(19) United States
(12) Patent Application Publication
(10) Pub. No.: US 2013/0167206 A1
(43) Pub. Date: Jun. 27, 2013

(54) STORAGE SYSTEM, METHOD OF CONTROLLING ACCESS TO STORAGE SYSTEM AND COMPUTER SYSTEM

(71) Applicant: FUJITSU LIMITED, Kawasaki-shi (JP)

(72) Inventor: Masahide HIROKI, Kawasaki (JP)

(73) Assignee: FUJITSU LIMITED, Kawasaki-shi (JP)

(21) Appl. No.: 13/775,298

(22) Filed: Feb. 25, 2013

Related U.S. Application Data
(63) Continuation of application No. PCT/JP2010/065838, filed on Sep. 14, 2010.

(51) Int. Cl. H04L 29/06

(52) U.S. Cl. CPC H04L 63/101
USPC 726/4

(57) ABSTRACT

A plurality of servers is connected to a storage system via a network. A control unit in the storage system defines exclusive access groups from an address information of each access interface of the servers, defines logical volumes in which the server is permitted to access for each of the exclusive access groups, and controls the access to the volume of the server by a access list which defines correspondence between the server and the logical volume and the physical volume, which are permitted to access by the server.

### CROSS-REFERENCE TO RELATED APPLICATION

This application is a continuation application of International Application PCT/JP2010/065838 filed on Sep. 14, 2010 and designated the U.S., the entire contents of which are incorporated herein by reference.

### FIELD

The embodiments discussed herein are related to a storage system, a method of controlling access of a storage system and a computer system.

### BACKGROUND

With an advancement of a computer system, in a computer system, a plurality of servers connect to a storage system via a switch, and reads and writes data. In the computer system, as a method to switch server in case of failure of the server, there is a method of switching by cluster software. However, in the method of switching by the cluster software, it is expensive to introduce the duster software, and it is necessary to create an application that corresponds to the cluster software.

Therefore, it is interesting to operate the server by cold standby configuration, since the introduction cost is relatively inexpensive, and it is not necessary to develop a dedicated application. The method of operating by the cold standby configuration is a method to prepare a plurality of servers of same configuration and to operate by switching another server in the event of a failure of one server.

FIG. 20 is a block diagram of the cold standby configuration. As illustrated by FIG. 20, two operation servers 100 and 102 and single standby server 104 for the cold standby are provided. Each of servers 100, 102, 104 has a pair of host bus adapters (HBA: Host Bus Adapter) 110, 112, 114, 116, 118 and 120. In addition, hardware of each of the servers 100, 102, 104 has same configuration.

Each of server 100, 102, 104 connects to a storage system 140 which is configured by a disk array device or the like via a pair of switches (FC: Fibre Channel switch, for example) 130, 132. In an example by FIG. 20, for redundant connections between the servers 100, 102, 104 and the storage system 140, a pair of the host bus adapters is provided for each of the servers 100, 102, 104, and a pair of the host adapters is connected to a pair of the switches 130, 132.

In the example by FIG. 20, a configuration, in which the servers 100, 102 are in operation and an operation is continuing by using the server 104 when one of the servers 100 or 102 has failed, is assumed. The server 100 and the server 102 are processing separate business, respectively. The storage system 140 stores system volume area 150 and user data area 152 of the server 100, and system volume area 156 and user data area 158 of the server 102. The system volume area 150, 156 stores software, parameters and log data to be executed by the servers 100, 102. The user data area 158 stores the user data associated with the processing of the servers 100, 102.

FIG. 21 is an explanatory diagram of an access control to the storage system in FIG. 20. As represented by FIG. 21, the access control is performed by each component (the servers, the FC switches, the storage system). The servers 100, 102, 104 perform the access control according to the target binding (referring to (1) in FIG. 21). In other words, the servers 100, 102, 104 specify the channel adapters which are an access interface to access the storage system 140. For example, WWN (World Wide Name) of the channel adapter 144 and 146 in the storage system, which is a target binding, is specified for every WWN (World Wide Name) of the host adaptor 110,102 in the server 100.

The FC switches 130, 132 have a server side port and a storage system side port. The FC switches 130, 132 perform the access control according to zoning (referring to (2) in FIG. 21). In other words, the FC switches 130 and 132 specify a pair of the WWN of the FC interfaces that can be accessed from each other. For example, the WWN of the host bus adapter on the server side and the WWN of the channel adapter on the storage system side are specified.

The storage system 140 performs the access control by LUN (Logical Unit Number) mapping (referring to (3) in FIG. 21). The LUN mapping is to convert a virtual LU (Logical Unit) to a physical LU (Logical Unit). That is, the definition of LUN mapping of the physical LU, which correspond to a virtual LU (virtual volume) which is looked virtually, is specified for each channel adapter of the storage system.

The storage system 140 performs by the WWN, which is a FC interface on the server, for each channel adapter (referring to (4) in FIG. 21). In other words, the WWN of the host bus adapter on the server side, which is accessible, is set to the channel adapter on the storage system 140.

In the cold standby configuration, for example, when determined that the operation can not continue due to the failure of the server 102, the standby server 104 is started using the system volume 156 of the server 102, and the operation of which the server 102 has been made continues. In order to access the system volume 156 and the user volume 158 of the failed server 102 by the standby server 104, it is necessary to set accessible ranges for each host bus adapter and for each channel adapter, as described. The setting is performed manually.

### RELATED ART

Japanese Laid-open Patent Publication No. 2005-11237
Japanese Laid-open Patent Publication No. 2003-131900

In the cold standby configuration, the storage system, in which the system volume is stored, is frequently used to share by a plurality of the servers, and the setting of the access control to the volume of the storage system and the setting of the access to the storage system tend to be complex. Because the settings is made by the user's manual operation, there may be an incorrect of the setting.

When the error of the setting occurs, single volume may be used by a plurality of servers, and there is a risk of data corruption. Double use causes serious problems, such that the server can not start and the user data is destroyed.

### SUMMARY

According to an aspect of the embodiments, a storage system which has a plurality of physical volumes which are accessed from a plurality of servers connected via a communication network path, includes a storage unit which stores a first definition information which defines an exclusive access group of the server by address information of each access interface of the plurality of servers, a second definition information which defines an identification number of a logical volume which is permitted to access by the server for each of the exclusive access groups, and an access list which defines correspondence of the server includes in the first definition information to the logical volume and the physical volume which are permitted to access in association with the first definition information and the second definition information, and a control unit which receives an access request from the server, determines the exclusive access group, in which the access request of the server belongs to, by referring the first definition information by an address information included in the access request of the server, determines there is the physical volume corresponding to the server by referring the access list by the exclusive access group which is determined that the access request of the server belongs when judging the access request of the server belong to the exclusive access group which is defined, and controls an access of the physical volume by result of the determination.

Further, according to another aspect of the embodiments, a computer system includes a plurality of servers in which each performs a business processing, and a storage system having a plurality of physical volumes which are accessed from the plurality of servers connected via a communication network path, and the storage system includes a storage unit which stores a first definition information which defines an exclusive access group of the server by address information of each access interface of the plurality of servers, a second definition information which defines an identification number of a logical volume which is permitted to access by the server for each of the exclusive access groups, and an access list which defines correspondence of the server includes in the first definition information to the logical volume and the physical volume which are permitted to access in association with the first definition information and the second definition information, and a control unit which receives an access request from the server, determines the exclusive access group, in which the access request of the server belongs to, by referring the first definition information by an address information included in the access request of the server, determines there is the physical volume corresponding to the server by referring the access list by the exclusive access group which is determined that the access request of the server belongs when judging the access request of the server belong to the exclusive access group which is defined, and controls an access of the physical volume by result of the determination.

Further, according to the other aspect of the embodiments, a method of controlling access to a storage system having a plurality of physical volumes to be accessed from a plurality of servers that are connected via a communication network path, includes receiving an access request from the server by a control unit, first determining an exclusive access group, in which the access request of the server belongs to, by referring a first definition information, which defines the exclusive access group of the server by address information of each access interface of the plurality of servers, by an address information included in the access request of the server, second determining there is the physical volume corresponding to the server by referring an access list, which defines correspondence of the server includes in the first definition information to the logical volume and the physical volume which are permitted to access in association with the first definition information and a second definition information, which defines an identification number of a logical volume which is permitted to access by the server for each of the exclusive access groups, by the exclusive access group which is determined that the access request of the server belongs when judging the access request of the server belong to the exclusive access group which is defined, and controlling an access of the physical volume by result of the determination.

The object and advantages of the invention will be realized and attained by means of the elements and combinations part particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a computer system according to the embodiment;

FIG. 2 is a block diagram of a storage system in FIG. 1;

FIG. 3 is an explanatory diagram of a access control to the storage device in FIG. 1 and FIG. 2;

FIG. 4 is a flow diagram of setting process of the access control in FIG. 1 and FIG. 2;

FIG. 5 is a flow diagram of the setting process of the access control to the storage system in FIG. 4;

FIG. 6 is an explanatory diagram of a definition of volume group in server 1A in FIG. 5;

FIG. 7 is an explanatory diagram of a definition of volume group in server 1B in FIG. 5;

FIG. 8 is an explanatory diagram of a definition of volume group in server 1C in FIG. 5;

FIG. 9 is an explanatory diagram of HBA definition of server in FIG. 5;

FIG. 10 is an explanatory diagram of an exclusive access group definition in FIG. 5;

FIG. 11 is an explanatory diagram of an access permission definition in an exclusive access group in FIG. 5;

FIG. 13 is a flow diagram of a volume access process according to an embodiment;

FIG. 14 is a flow diagram setting process at the time of switching the server according to the embodiment;

FIG. 15 is an explanatory diagram of the access list by setting process in FIG. 14;

FIG. 16 is a process flow diagram of volume access according to a comparative Example;

FIG. 17 is an explanatory diagram of the setting range of volume access according to a comparative example;

FIG. 18 is an explanatory diagram of setting range of volume access according to the embodiment;

FIG. 19 is a block diagram of a computer system according to another embodiment;

FIG. 20 is a block diagram of a cold standby configuration; and

FIG. 21 is a diagram illustrating access control to the storage system in FIG. 20.

### DESCRIPTION OF EMBODIMENTS

Hereinafter, embodiments will be described in order of a first embodiment of a computer system, a setting process of access information, a volume access process, a process of change to a standby system, another embodiment of the computer system, and other embodiments, but the disclosed computer system and the storage system are not limited to the embodiments.

(First Embodiment of the Computer System)

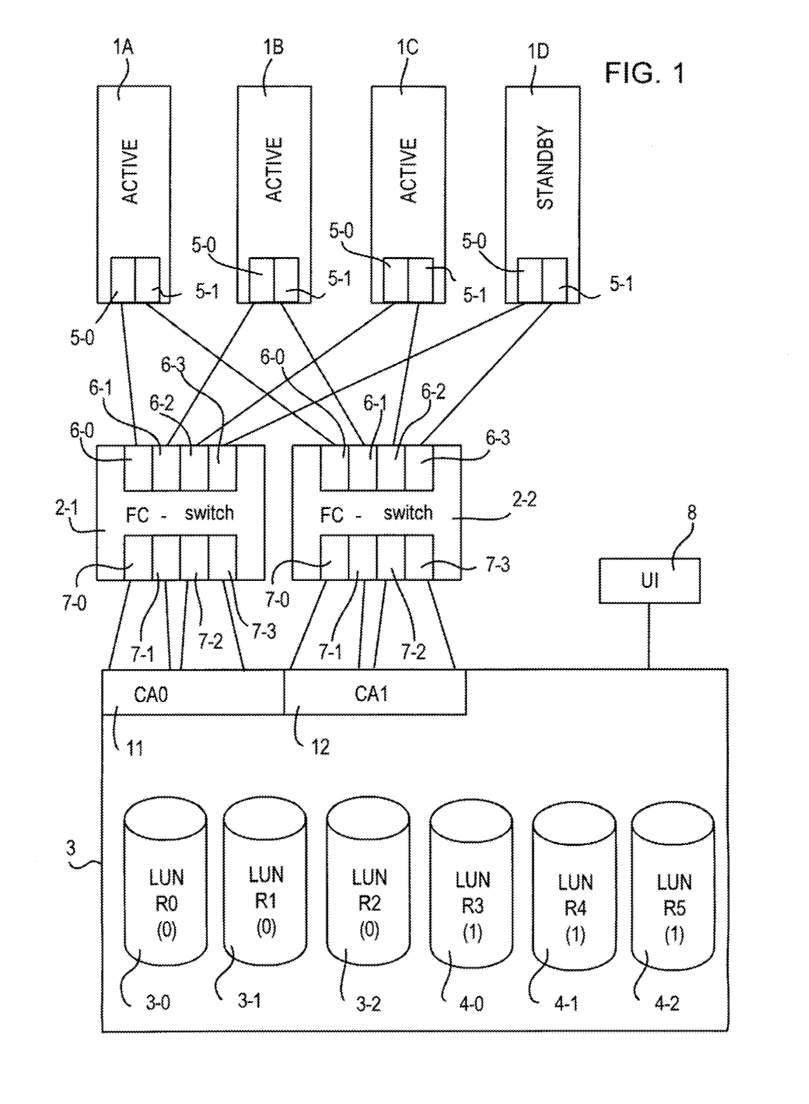

FIG. 1 is a block diagram of the computer system according to the embodiment. As illustrated by FIG. 1, the computer system includes a plurality of processing devices 1A˜1D. In an example of FIG. 1, three processing devices (hereinafter, referred to as a server) 1A, 1B, 1C configure an active processing system, and single server 1D configures a standby processing device for cold standby.

Each of the servers 1A, 1B, 1C, 1D includes at least a pair of host bus adapters (HBA: Host Bus Adapter) 5-0, 5-1, one or more processing device (CPU: Central Processing Unit) and a storage unit.

The servers 1A, 1B, 1C, 1D connect to the storage system 3 via a pair of switches (FC (Fibre Channel) switch) 2-1, 2-2. In the example of FIG. 1, in order to realize redundant connections between the servers 1A, 1B, 1C, 1D and the storage system 3, one host bus adapter 5-0 in each of the servers 1A, 18, 1C, 1D connect to a first switch 2-1, and another host bus adapter in each of the servers 1A, 1B, 1C, 1D connect to a second switch 2-2.

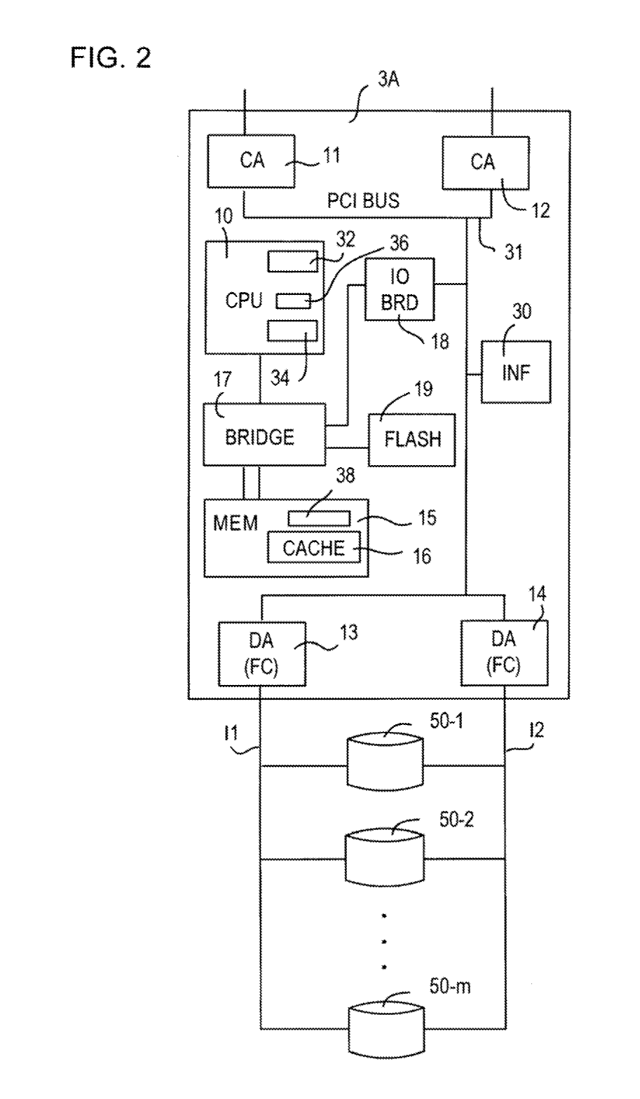

Each of the switches 2-1 and 2-2 includes four ports 6-0˜6-3 on the server side, and four ports 7-0˜7-3 on the storage system side. For example, the first and second switches 2-1 and 2-2 has a FC (Fibre Channel) switch. The storage system 3 has a plurality of storage devices as described below in FIG. 2. For example, the storage system 3 includes a disk array device.

The storage system 3 has at least two channel adapters 11 and 12. One channel adapter 11 connects to each of the ports 7-0˜7-3 in the first switch 2-1. Another channel adapter 12 connects to each of the ports 7-0˜7-3 in the second switch 2-2. The channel adapters in the storage system 3 also employ the redundant configuration. Configuration of the storage system will be described in detail in FIG. 2.

The storage system 3 has system volume area (described as LUN R0 (0)) 3-0 and user data area (described as LUN R3 (1)) 4-0 of the server 1A, system volume area (described as LUN R1 (0)) 3-1 and user data area (described as LUN R4 (1)) 4-1 of the server 1B, and system volume area (described as LUN R2 (0)) 3-2 and user data area (described as LUN R5 (1)) 4-2 of the server 1C.

The system volume area 3-0˜3-2 store software to be executed by the servers 1A˜1C, parameters and log data. The user data area 4-0˜4-2 store user data associated with the processing of the servers 1A˜1C. The storage system 3 does not have a volume region of the standby server 1D. In other words, in the example, when switching from a failed server to the standby server 1D, the server 1D uses the volume area of the failed server. This type is called as share type.

In addition, a user interface device (described as UI in FIG. 1) 8 connects to the storage system 8. The user interface device 8 includes a keyboard, a display device and a processing unit. The user interface device 8 executes various settings for the storage system 3 by the user, and monitors and displays such as the status of the storage system 3. The user interface device 8 is configured by a personal computer, for example.

FIG. 2 is a block diagram of the storage system 3 in FIG. 1. An example illustrated by FIG. 2 represents a configuration with a single storage controller. However, the configuration may be configured by a plurality of storage controllers. As illustrated by FIG. 2, the storage system 3 includes the storage controller (hereinafter referred to as controller) 3A, and a plurality of storage devices 50-1˜50-m which are connected to the controller 3A via a pair of signal lines I1, I2. For example, the storage device 50-1˜50-m has a magnetic disk device (HDD: Hard Disk Device).

The controller 3A connects to the servers 1A˜1D through the switches 2-1, 2-2, and reads and writes a large amount data of the server to the disk drives (magnetic disk drives) which configures RAID (Redundant Array Independent Disk) with a higher speed and random. The controller 3A includes a pair of channel adapters (CA: Channel Adapter) 11, 12, a control module (CM: Control Module) 10, 15˜19, and a pair of device adapters (DA: Device Adapter) 13, 14.

The channel adapters (hereinafter referred to as CA) 11, 12 are a circuit that controls the host interface with the server. For example, the CA 11, 12 includes a Fibre Channel (FC) circuit and a DMA (Direct Memory Access) circuit. The device adapters (hereinafter, referred to as DA) 13, 14 are a circuit for controlling the 50-1˜50-m magnetic disk device 13, 14 is a circuit which transmits and receives command and data to and from the magnetic disk devices for controlling the magnetic disk devices 50-1˜50-m. For example, the DA 13, 14 includes a Fibre Channel (FC) circuit and a DMA circuit.

The control module (hereinafter, referred to as CM) includes a central processing unit (CPU: Central Processing Unit) 10, a bridge circuit 17, a memory (RAM: Random Access Memory) 15, a nonvolatile memory (hereinafter referred to as flash memory) 19, and an IO (Input/Output) bridge circuit 18. The memory 15 is backed up by a battery, a memory 15, and a portion of the memory 15 is used as a cache memory 16.

The central processing unit (hereinafter referred to as CPU) 10 connects to the memory 15, the flash memory 19, and the IO bridge circuit 18 via the bridge circuit 17. The memory 15 is used for work area of the CPU 10. The flash memory 19 stores a program executed by the CPU 10.

The flash memory 19 stores OS (Operating System), BIOS (Basic Input/Output System), a file access program (read/write programs), and control program (module) such as RAID management program, as the program. The CPU 10 runs the program, and performs the read/write processing and the RAID management processing, as will be described later.

PCI (Peripheral Computer Interface) bus 31 connects the CA 11, 12 with the DA 13, 14 and connects the CPU 10 with the memory 15 via the IO bridge circuit 18. In addition, the PCI bus 31 is connected an external interface circuit (described as INF) 30 which is connected to the user interface device 8.

In an example of FIG. 2, the storage devices (hereinafter referred to as disk device) 50-1˜50-m constitute the physical volume. In other words, the system volume area 3-0˜3-2 and the user data area 4-0˜4-2 in FIG. 1 are assigned to the disk devices 50-1-50-m.

The cache memory 16 stores a part of data in the disk device which is charged and write data from the server and read data corresponding to the previous read request from the server. The CPU 10 receives a read request from the server via the CA 11, 12, determines whether or not an access to the physical disk is necessary by referring to the cache memory 16, and requests a disk access request to the DA 13, 14 when the access to the physical disk is necessary. Also, the CPU 10 receives a write request from the server, writes write data into the cache memory 16 and requests write back which is scheduled inside to the DA 13, 14.

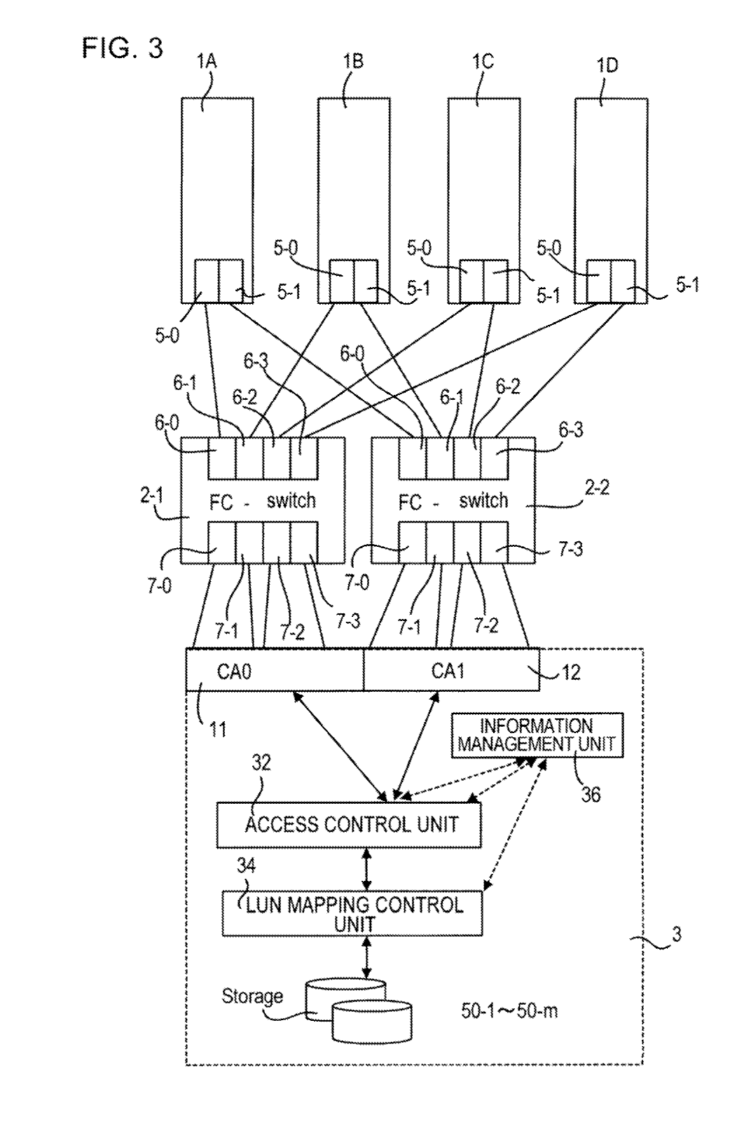

In the embodiment, the CPU 10 performs functions of information management unit 36, access control unit 32 and LUN mapping control unit 34, as described in FIG. 3. In addition, the memory 15 includes a list area 38 which stores information that has been set.

FIG. 3 is an explanatory diagram of the storage system in FIG. 2. In FIG. 3, same elements as those described in FIG. 1 and FIG. 2 are indicated by same symbols. As illustrated by FIG. 3, the information management unit 36 sets accessible storage volume group for application (purpose) of the server which performs the operation, and sets and holds the server group which are accessible to these storage volume group. That is, the information management unit 36 creates an access list as described later according to the volume group and the server group that are set by the user from the user interface device 8, and stores the access list in the list area 38 in the memory 15.

The access control unit 32 holds information of the HBA (Host Bus Adapter) in the server, and determines whether or not access from the server is enable by referring to the access list based on the information of the HBA of the server. The LUN mapping control unit 34 performs mapping control of the storage volume for each application of the server based on the access list.

As will be described in detail below, when switching a server operated by the cold standby, it is performed to change the access list and to switch the server group which is accessible to set the storage volume group in the storage system 3 (disk array device). This prevents setting errors for performing access to the storage system by the standby processor, and it is possible to realize an efficiency of the switching operation.

(Setting Process of Access Information)

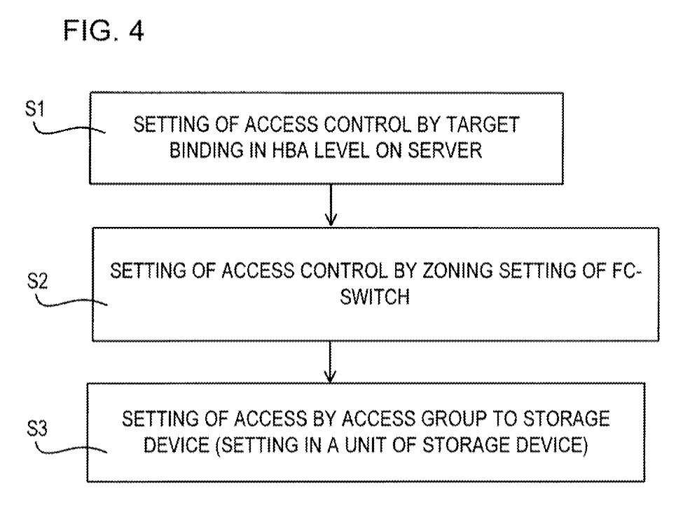

FIG. 4 is a process flow diagram of access information setting process according to the embodiment.

(S1) It is performed to set the WWN of the channel adapters 11 and 12 of the storage system 3, which is target binding, for every WWN (World Wide Name) of the host adapters 5-0, 5-1 in the server 1A˜1D. By this procedure, it is performed to set the access control by the target binding in the HBA level.

(S2) Then, it is performed to specify a pair of WWN of the FC interface that can access each other in the FC switches 2-1, 2-2. For example, the WWN of the host bus adapter on the server side and the WWN of the channel adapter on the storage system side are specified. Thus, it is performed to set the access control of the FC switches 2-1, 2-2 by the zoning. The setting in steps S1 and S2 is performed to set to the servers 1A˜1D and switches 2-1 and 2-2 from system controller which is not illustrated in FIG. 1.

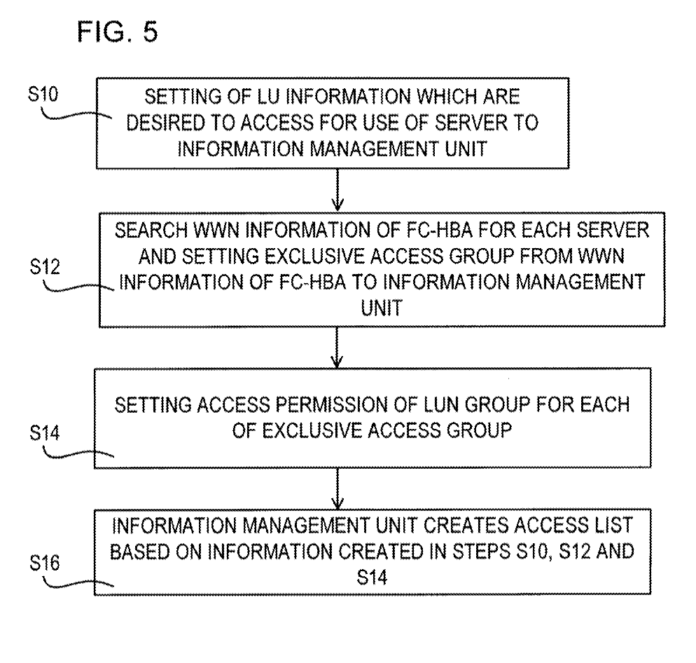

(S3) Setting of the access control by access group, which accesses to the storage system 3, is performed. As will be described below in FIG. 5, the setting information is entered from the user interface device 8, and the information management unit 36 performs the setting in unit of the storage device.

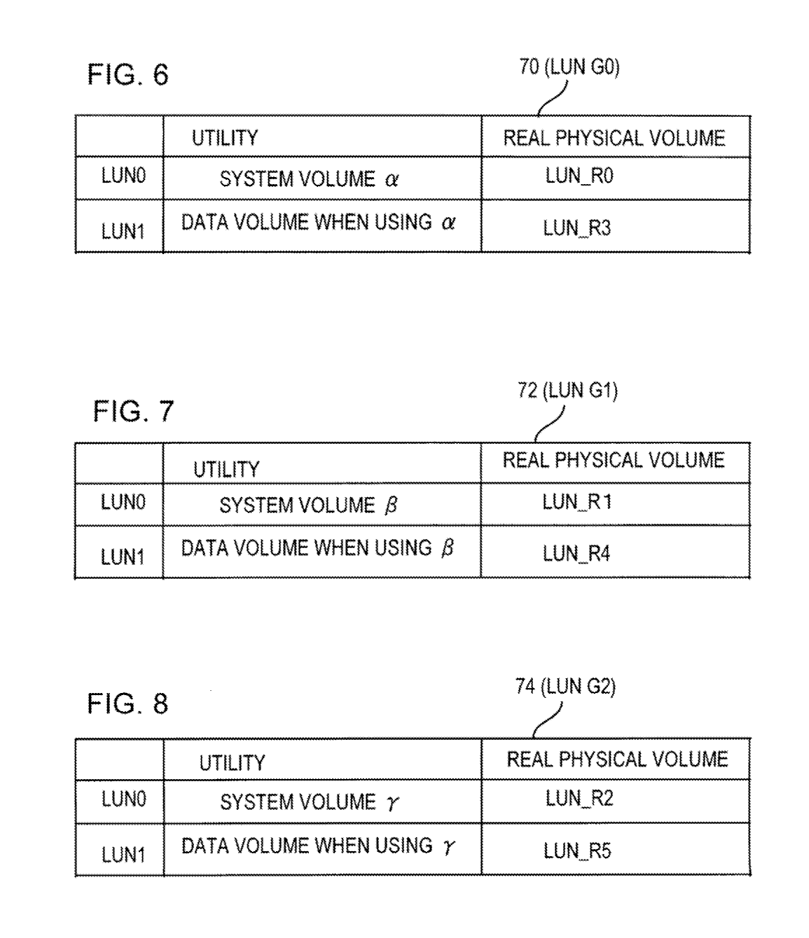

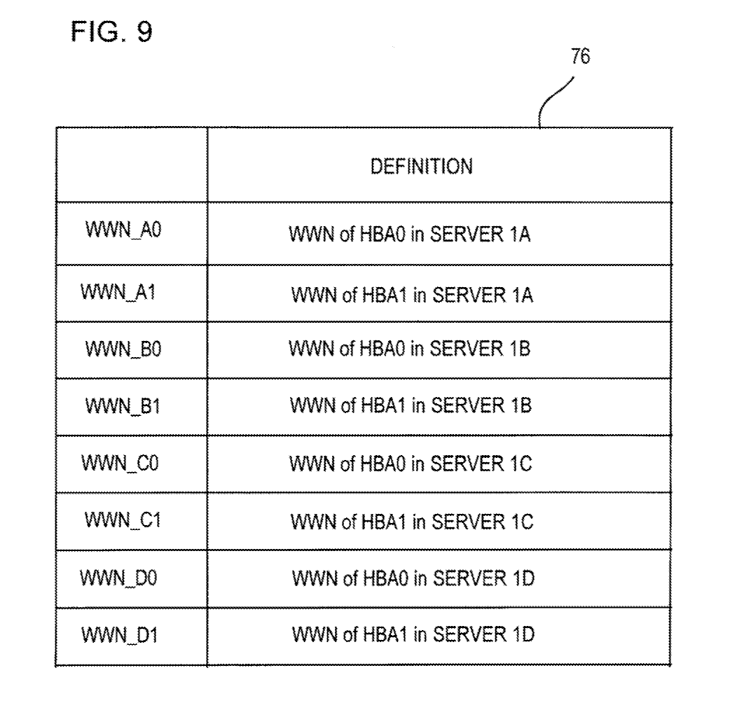

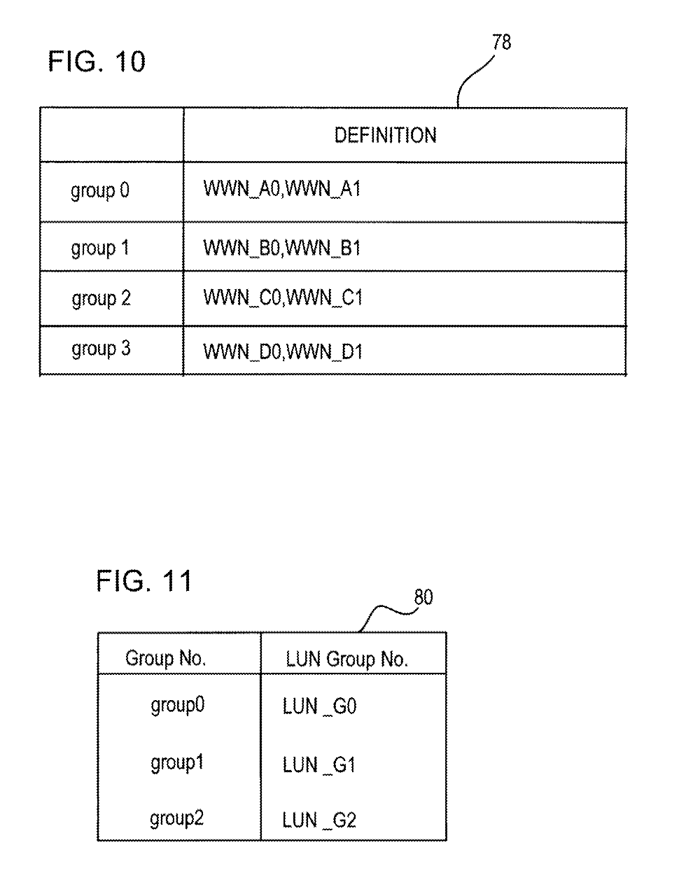

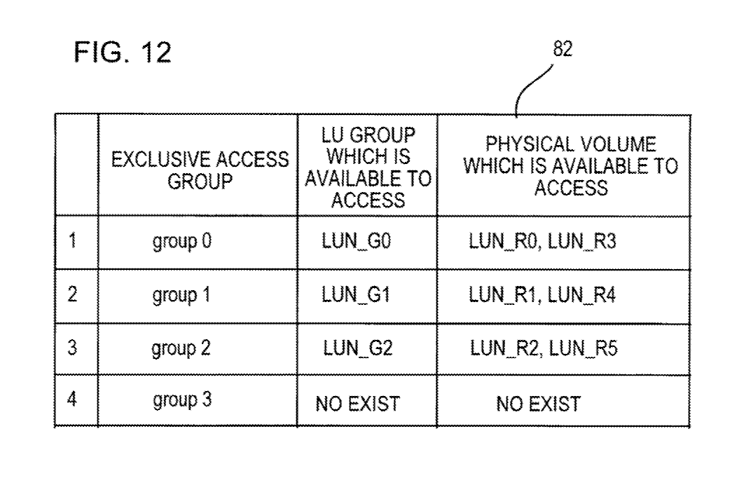

Next, the access setting process in the step S3 of FIG. 4 will be explained by using FIG. 5, FIG. 5 is a flow diagram of access setting process in the storage system according to the embodiment. FIG. 6, FIG. 7 and FIG. 8 are explanatory diagrams of the LU mapping definition table in FIG. 5. FIG. 9 is an explanatory diagram of the HBA identification information table in the server in FIG. 5. FIG. 10 is an explanatory diagram of a setting table of exclusive access group in FIG. 5. FIG. 11 is an explanatory diagram of an access permission setting table in FIG. 5. FIG. 12 is an explanatory diagram of an access list in FIG. 5. The information management unit 36 executes the process described in FIG. 5.

The access information setting processing, of which the information management unit 36 in FIG. 5 executes, will be described below with reference to FIG. 6 to FIG. 12.

(S10) The user sets information of the logical unit (LU), in which the user desires to access, for each application of the server to the information management unit 36 from the user interface device 8. For example, in the configuration described in FIG. 1, in a case that three system volumes are prepared to the storage system 3, as the application of the server, the LU mapping definitions described in FIG. 6, FIG. 7 and FIG. 8 are set. As illustrated by FIG. 6, in LU mapping definition (LUN_G0) 70 when using a first system volume α, the logical unit number LUN 0 and the physical volume LUN_R0 are set to the system volume α. When setting up a data volume to the system volume α, the logical unit number LUN 1 and the physical volume LUN_R3 are set to the data volume of the system volume α.

As illustrated by FIG. 7, in LU mapping definition (LUN_G1) 72 when using a second system volume β, the logical unit number LUN 0 and the physical volume LUN_R1 are set to the system volume β. When setting up a data volume to the system volume β, the logical unit number LUN 1 and the physical volume LUN_R4 are set to the data volume of the system volume β

As illustrated by FIG. 8, in LU mapping definition (LUN_G2) 74 when using a third system volume γ, the logical unit number LUN 0 and the physical volume LUN_R2 are set to the system volume γ. When setting up a data volume to the system volume γ, the logical unit number LUN 1 and the physical volume LUN_R5 are set to the data volume of the system volume γ.

As described in FIG. 1, by the definitions 70, 72, 74, the system volume area (LUN R0 (0)) 3-0 and the user data area (LUN R3 (1)) 4-0, and the system volume area (LUN R1 (0)) 3-1 and the user data area (LUN R4) 4-1, and the system volume area (LUN R2 (0)) 3-2 and the user data area (LUN R5 (1)) 4-2 are reserved in the storage system 3.

(S12) The user sets the WWN information of the host bus adapter (HBA) for each server and sets the exclusive access group to the information management unit 36 from the user interface device 8. The information management unit 36 creates a HBA identification table 76 from the setting information that has been entered. The example will be explained by the configuration of four servers 1A˜1D which has two host bus adapters (HBA) respectively. As illustrated by FIG. 9, in the HBA identification table 76, the WWN of the first HBA 5-0 and the WWN of the second HBA 5-1 in the server 1A are set to identifier WWN_A0, the identifier WWN_A1, respectively. The WWN of the first HBA 5-0 and the WWN of the second HBA 5-1 in the server 1B are set to identifier WWN_B0, the identifier WWN_B1, respectively. The WWN of the first HBA 5-0 and the WWN of the second HBA 5-1 in the server 1C are set to identifier WWN_C0, the identifier WWN_C1, respectively. The WWN of the first HBA 5-0 and the WWN of the second HBA 5-1 in the server 1D are set to identifier WWN_D0, the identifier WWN_D1, respectively.

Next, the user sets the exclusive access group to the information management unit 36 from the user interface device 8. As illustrated by FIG. 10, the information management unit 36 creates the exclusive access group list 78 which are set the identifier WWN_A0, WWN_A1 of the HBA 5-0, 5-1 of the server 1A to a group 0, set the identifier WWN_B0, WWN_B1 of the HBA 5-0, 5-1 of the server 1B to a group 1, set the identifier WWN_C0, WWN_C1 of the HBA 5-0, 5-1 of the server 1C to a group 2, and set the identifier WWN_D0, WWN_D1 of the HBA 5-0, 5-1 of the server 1D to a group 3. In other words, the WWN of the HBA are classified into the access groups 0-3, and are used to the exclusive control.

(S14) The user sets access permissions of the LUN groups LUN_G0˜LUN_G2 for each of the exclusive access group to the information management unit 36 from the user interface device 8. As illustrated by FIG. 11, the information management unit 36 creates a access permission table 80 which is set the access groups 0˜2 to permits the access for the LUN groups LUN_G0˜LUN_G2 set in FIG. 5, FIG. 6 and FIG. 7.

(S16) The information management unit 36 creates the access list 82, which is represented by FIG. 12, from the LU mapping definition 70, 72, 74, the HBA identification table 76, the exclusive access group list 78 and the access permission table 80, which are created in the steps S10˜S14 and FIG. 6˜FIG. 8. As illustrated by FIG. 12, the access list 82 is a list that stores the physical volumes that are accessible in association with the accessible LUN groups of the exclusive access groups 0˜3 in FIG. 11.

In the example of FIG. 12, the LUN group to permit access to the exclusive access group 3 has not been set in the access permission table 11 of FIG. 11. Therefore, in FIG. 12, the accessible LUN groups LUN_G0˜LUN_G2 and accessible physical volumes LUN_R0 and LUN_R3, LUN_R1 and LUN R4, LUN_R4 and LUN_R2, which are set in FIG. 6, FIG. 7 and FIG. 8, are set to the exclusive access group 0˜2 in FIG. 10 and FIG. 11.

In addition, the accessible LUN group and the accessible physical volume are not set for the exclusive access group 3. Therefore, as described in FIG. 1, the HBA 5-0, 5-1 of the server 1A are allowed to access the system volume area (LUN R0 (0)) 3-0 and the user data area (LUN R3 (1)) 4-0. Also, the HBA 5-0, 5-1 of the server 1B are allowed to access the system volume area (LUN R1 (0)) 3-1 and the user data area (LUN R4 (1)) 4-1.

In addition, the HBA 5-0, 5-1 of the server 1C are allowed to access the system volume area (LUN R2 (0)) 3-2 and the user data area (LUN R5 (1)) 4-2. The server 1D is not allowed to access any of the system volume area and the user data area in the storage system 3. Therefore, it is possible to prevent the duplication of the access by the operating server and the standby server.

In addition, the information management unit 36 stores the LU mapping definitions 70, 72, 74, the HBA identification table 76, the exclusive access group list 78, the access permission table 80 and the access list 82, which are created, into the list area 80 of the memory 15.

(Volume Access Processing)

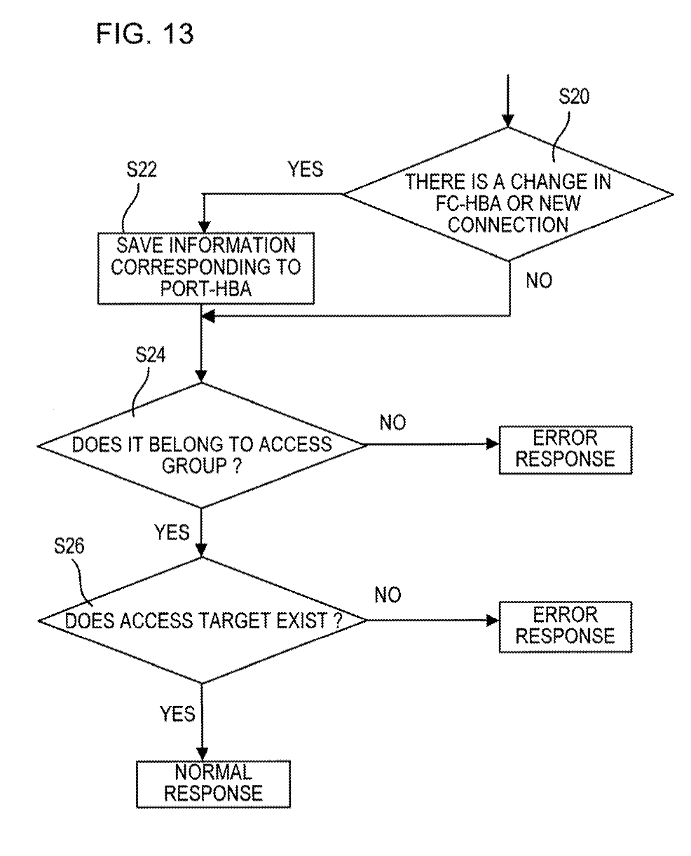

Next, following describes the processing of the volume access of the storage system using such as the access list, which is created by the information management unit 36. FIG. 13 is a flow diagram of the volume access process according to the embodiment.

(S20) The servers 1A˜1C sends an access request (I/O request) to the CA 11, 12 in the storage system 3 via the switches 2-1 and 2-2. The access control unit 32 in the CPU 10 processes the access request which is received by the CA 11, 12. First, the access control unit 32 of the CPU 10 determines whether or not the access from the HBA in the server is received for the first time. For example, the access request includes the WWN and a port identifier (port ID) of the HBA. The access control unit 32 determines that the access from the HBA is received for the first time when there is a change to the HBA received or when a new server is connected.

(S22) When the access control unit 32 determines that the access from the HBA is received for the first time, the access control unit 32 records (saves) correspondence between the port ID and the HBA. The port ID is an identifier that changes dynamically depending on the environment during operation. However, since the port ID of the HBA which issued is assigned for all I/O requests, the access control unit 32 can easily determine which HBA requests the I/O request. And in the embodiment, the WWN information and the port. ID form a pair and the pair is used for the access control. For example, when receiving an access from the HBA with the port ID “0x000001”, the CPU 10 in the storage system 3 obtains the WWN information from login information (PLOGI) which is received when connecting to the server. Then, the access control unit 32 stores the correspondence information between the port ID=0x000001 and the WWN_A0.

(S24) The access control unit 32 accepts the I/O request from the server, and identifies the WWN of the HBA from the port ID information contained in a frame of the I/O request. The access control unit 32 determines that the WWN belongs to which exclusive access group by referring to the table 76, 78 in FIG. 9 and FIG. 10. The access control section 32 passes the I/O request to the LUN mapping unit 34, when the HBA belongs to either one of the exclusive access groups. In addition, the access control unit 32 responds an error for the I/O request to the server, when the HBA does not belong to any of the exclusive access groups. For example, the access control unit 32 extracts the WWN_A0 that corresponds to the port ID “0x000001” from the correspondence between the WWN and the port ID that are saved and the table 76 in FIG. 9, then extracts the exclusive access group of group 0 from the table 78 in FIG. 10.

(S26) The LUN mapping control unit 34 selects the corresponding LUN group according to the access list 82 (referring to FIG. 12) which is created by the information management unit 36, and performs permission to access the physical volume. That is, the LUN mapping control unit 34, when receiving the I/O request from the access control unit 32, determines that the I/O request belongs to which access group in the access list 82, and determines whether or not the I/O request is issued to the physical volume which is permitted the access. Then, the LUN mapping control unit 34, when determining that the I/O request was issued to the physical volume which is permitted the access, determines that the access is permitted and performs normal response. That is, the LUN mapping control unit 34 accesses the physical volume which is permitted to access by the I/O request, and returns the response to the server. The LUN mapping control unit 34, when the physical volume to be accessed is not present or when the I/O request is outside the range of the physical volume to be accessed by a result of referring to the access list 82, responds an error to the server. For example, in the example of FIG. 9˜FIG. 12, the WWN_A0 is extracted from the port ID “0x000001”, and the group 0 is extracted from the WWN_A0, then the LUN_G0 is extracted from the group 0. Therefore, it is possible to access the physical volumes LUN_R0 and LUN_R1.

For subsequent accesses from the server, the access control unit 3.2 and the LUN mapping control unit 34 determine whether or not the access is enable by the port ID as a key, while not changing the HBA information HBA, that is, while no change in the correspondence between the WWN information and the port ID. In addition, the access control unit 32, when detecting a change in the correspondence between the WWN information and the port ID, discards the port ID information corresponding to the WWN information and again performs the processing from the step S22 in the process flow.

(Process of Switching to the Standby System)

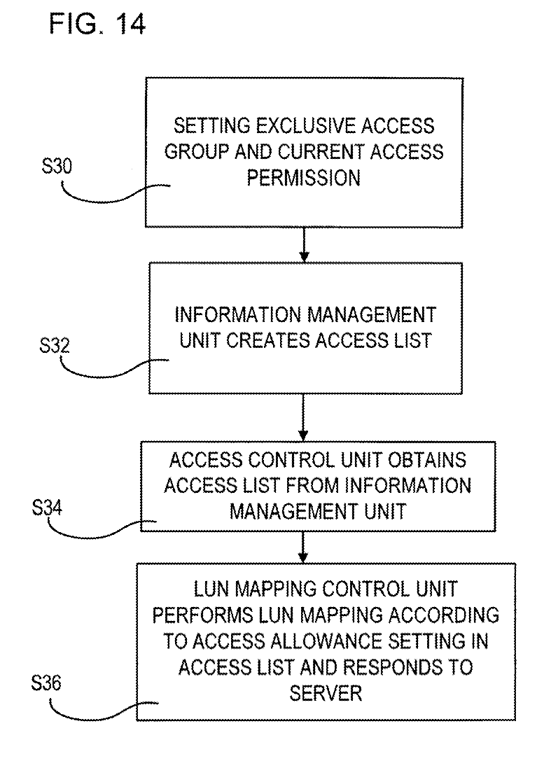

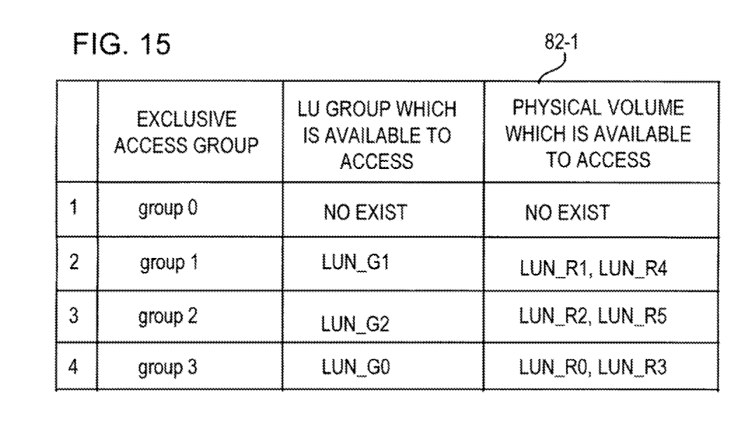

FIG. 14 is a flow diagram of a process of switching the cold standby according to the embodiment. FIG. 15 is an explanatory diagram of changing the access list by a process in FIG. 14.

(S30) When constructing the environment of the computer system, a variety of tables have been created by the setting processes in FIG. 4 and FIG. 5. When the server switching has occurred by the cold standby, it is performed to change the setting by the processes of the step S14 and the step S16 in FIG. 5. The user sets the access permissions of the LUN group LUN_G0˜LUN_G2 for each exclusive access groups to the information management unit 36 from the user interface device 8. For example, in a case of switching the operation of the server 1A to the server 1D due to a failure of the server 1A, the user sets to change the access permission groups of the LUN group LUN_G0˜LUN_G2 set in FIG. 6˜FIG. 8 to the group 3, group 1 and group 2. The information management unit 36 creates the access permission table 80 which corresponds to the setting.

(S32) The information management unit 36 creates the access list 82-1 illustrated by FIG. 15 from the LU mapping definition 70, 72, 74, the HBA identification table 76, the exclusive access group list 78 and the access permission table 80 which are created in the steps S10˜S14, as depicted by FIG. 6˜FIG. 8. As represented by FIG. 15, the access list 82 is a list that stores the corresponding accessible physical volume to the accessible LUN group of the exclusive access group 0˜3 in FIG. 11.

In an example of FIG. 15, the access permission LUN group is not set to the exclusive access group 0 (the server 1A) and the access permission LUN group is set to the exclusive access group 3 (the server 1D) in the access permission table 80 by the process in the step S30. Therefore, the accessible LUN group LUN_G1, the accessible physical volumes LUN_R1 and LUN_R4 is set to the exclusive access group 1, and the accessible LUN group LUN_G2, the accessible physical volumes LUN_R2 and LUN_R5 is set to the exclusive access group 2, and the accessible LUN group LUN_G0, the accessible physical volumes LUN_R0 and LUN_R3 is set to the exclusive access group 3, in FIG. 10 and FIG. 11.

Also, accessible LUN group and the physical volume that is accessible is not set for the exclusive access group 0. That is, in the access list 80 in FIG. 12, the accessible LUN group LUN_R0 and the accessible physical volume LUN_G0 that can be accessed with the server 1A are moved to the exclusive access group 3 which is used by the server 1D.

For this reason, the HBA 5-0, 5-1 of the server 1D which is switched are permitted to access the system volume area (LUN R0 (0)) 3-0 and the user data area (LUN R3 (1)) 4-0 that has been used by the failed server 1A. Also, the HBA 5-0, 5-1 of the server 1B are permitted to access the system volume area (LUN R1 (0)) 3-1 and the user data area (LUN R4 (1)) 4-1.

In addition, the HBA 5-0, 5-1 of the server 1C are permitted to access the system volume area (LUN R2 (0)) 3-2 and the user data area (LUN R5 (1)) 4-2. The server 1A which failed is not permitted to access any of the system volume area and the user data area in the storage system 3.

(S34) Later, the access control unit 32 performs same processing as the steps S20˜S24 in FIG. 13 by referring to the access list 82-1 that have been modified.

(S36) And, the LUN mapping control unit 34 performs same process as the step S26 in FIG. 13 depending on the setting in the access permission list 82-1 that have been modified.

Thus, when switching the server in the cold standby configuration, by easy and simple setting to change the access permission setting for the exclusive group in the access list, it is possible to prevent the duplication of access of the server. Further, the server 1D was switched can continue the processing of the failed server 1A.

In addition, by notifying which servers are using which applications to the information management unit from an external device, at the time of switching cold standby, the information management unit may update the access list automatically. With this configuration, it is possible to automate the change of the setting for the cold standby operation.

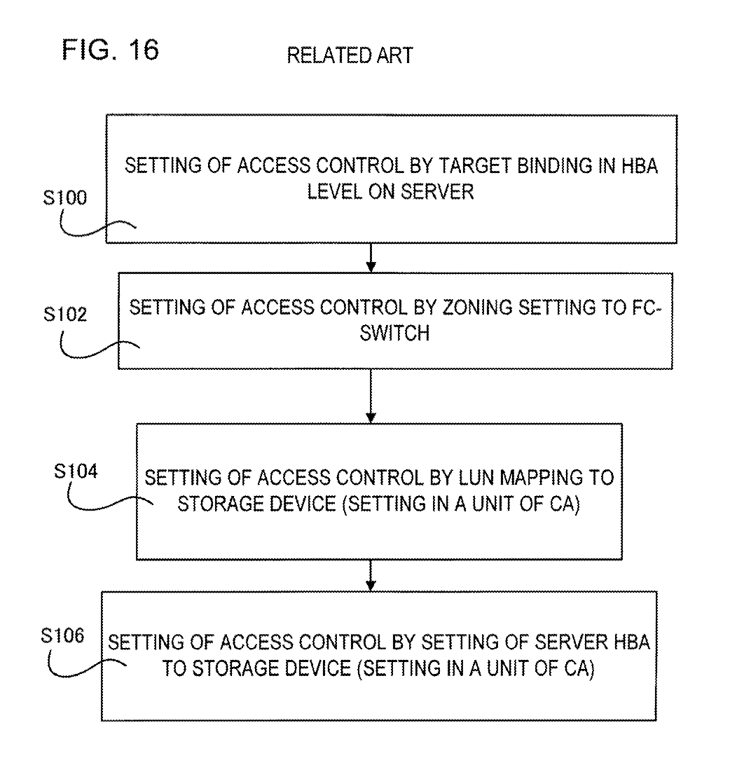

Next, a comparative example, which processes setting up when switching cold standby, will be described by using FIG. 16. FIG. 16 is a flow diagram of a setting process at the time of switching the cold standby according to the comparative example.

(S100) In the same manner as in the step S1 of FIG. 4, it is performed to set the WWN of the channel adapters 11 and 12 of the storage system 3, which is target binding, for every WWN (World Wide Name) of the host adapters 5-0, 5-1 in the server 1A˜1D. By this procedure, it is performed to set the access control by the target binding in the HBA level.

(S102) In the same manner as in the step S2 in FIG. 4, it is performed to specify a pair of WWN of the FC interface that can access each other in the FC switches 2-1, 2-2. For example, the WWN of the host bus adapter on the server side and the WWN of the channel adapter on the storage system side are specified. Thus, it is performed to set the access control of the FC switches 2-1, 2-2 by the zoning.

(S104) The access control of the LUN mapping is set to the storage system 3 for every channel adapters. That is, the LUN mapping, which is virtually looked and explained by FIG. 6˜FIG. 8, are set for each CA of the storage system 3. When switching the server in the cold standby, the LUN mapping is switched for each of CA.

(S106) The access control by the server HBA in the storage system is set on a per-channel adapter basis. That is, the HBA described in FIG. 9 and FIG. 10 are set for each of CA of the storage system 3. When switching the server in the cold standby, the setting table is switched for each of the CA.

Therefore, in the comparative example, it is necessary to repeat the setting in the steps S104 and S106 for the number of the HBA which is affected by the switching. For example, in the configuration of FIG. 1, because the number of HBA, which are affected, is four, it necessary to repeat four times of the step S104 and step S106. Therefore, because the setting items are many and complicated, there is a possibility of incorrect settings.

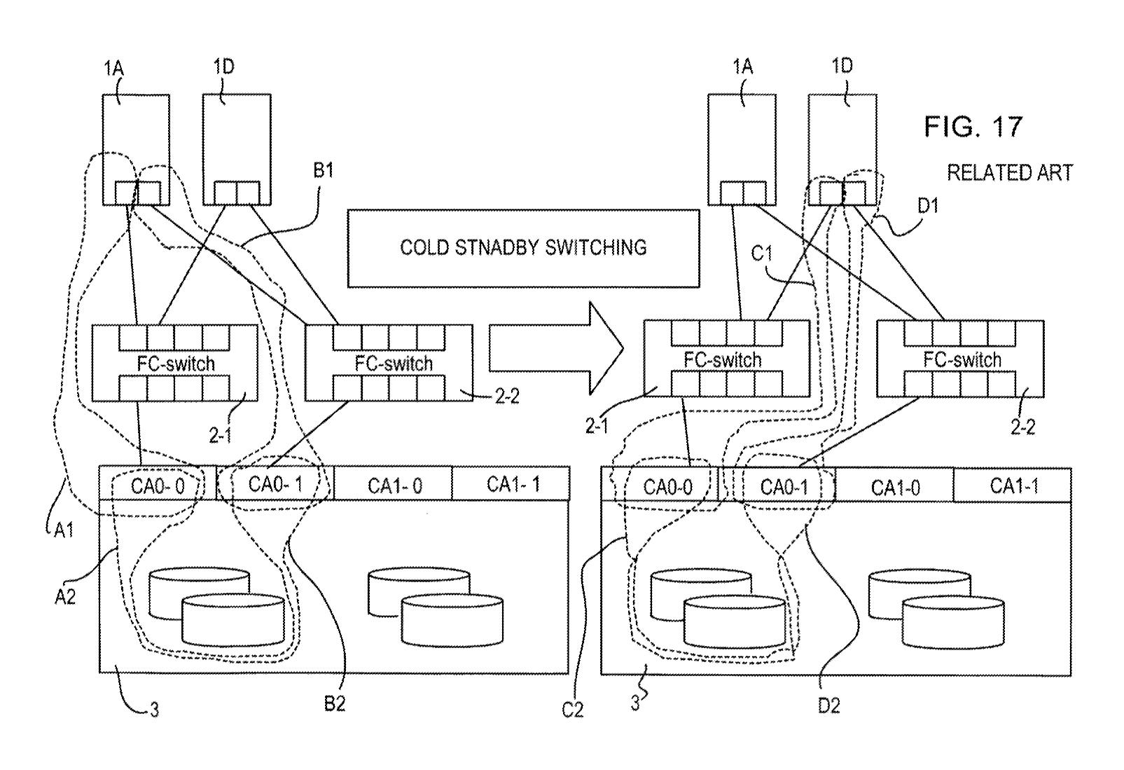

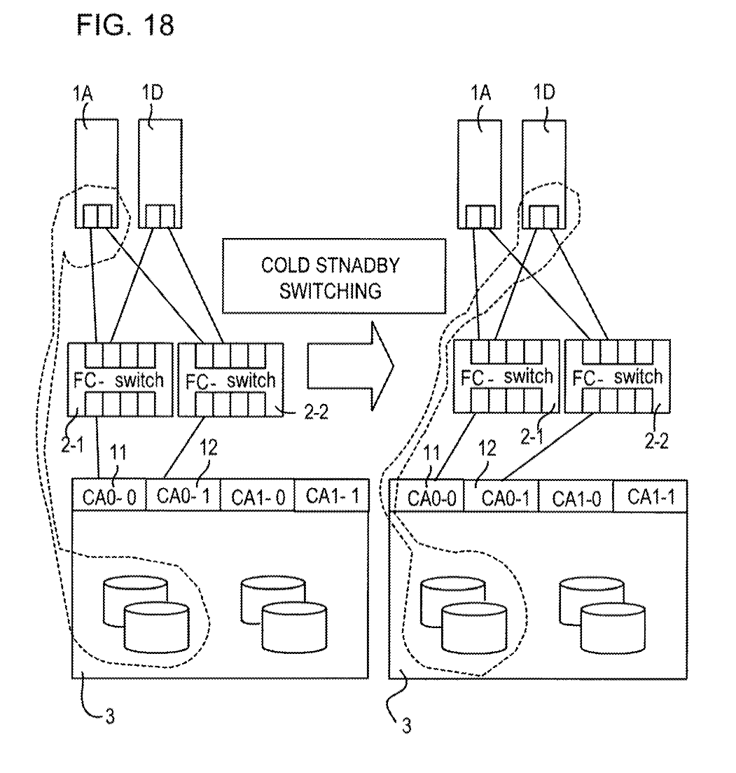

FIG. 17 is an explanatory diagram of an accessible range by the setting according to the comparative example. FIG. 18 is an explanatory diagram of the accessible range according to the embodiment. In FIG. 17 and FIG. 18, same elements as that described in FIG. 1, are indicated by same symbols. The dotted lines in FIG. 17 and FIG. 18 indicate the accessible range by the setting. As illustrated by FIG. 17, in the comparative example, because the accessible ranges are set for each of the host bus adapter HBA and of the channel adapter CA, the accessible range of the server 1A is separated into a first range to the channel adapters as indicated by the dotted lines A1, B1 and a second range the channel adapter to the physical volume, as indicated by the dotted lines A2, 82.

For this reason, when switching to the server 1D in the cold standby, it is necessary to set the access range to the dotted lines C1, D1, C2, D2 in a unit of the HBA and in a unit of the CA. In other words, it is necessary to set up four times.

On the other hand, in the embodiment of FIG. 18, because of setting of the access control by the access groups which includes the HBA and the physical volume, when switching to the server 1D in the cold standby, the setting is necessary only once in a unit of the access group. Further, because the setting does not depend on the channel adapter, when changing the channel adapter connected to the storage system, it is not necessary to change the settings. That is, even if the channel adapter of the storage system 3 fails, it is not necessary to change the setting of the access control, and it is possible to continue to operate using the other channel adapter.

In addition, in a case that the storage device is connected in SAS (Serial Attached SCSI), the management of the WWN of the server HBA described in the embodiment is changed to the management of SAS address of the HBA. In this way, the setting in the embodiment can also be applied to SAS connect system.

(Another Embodiment of the Computer System)

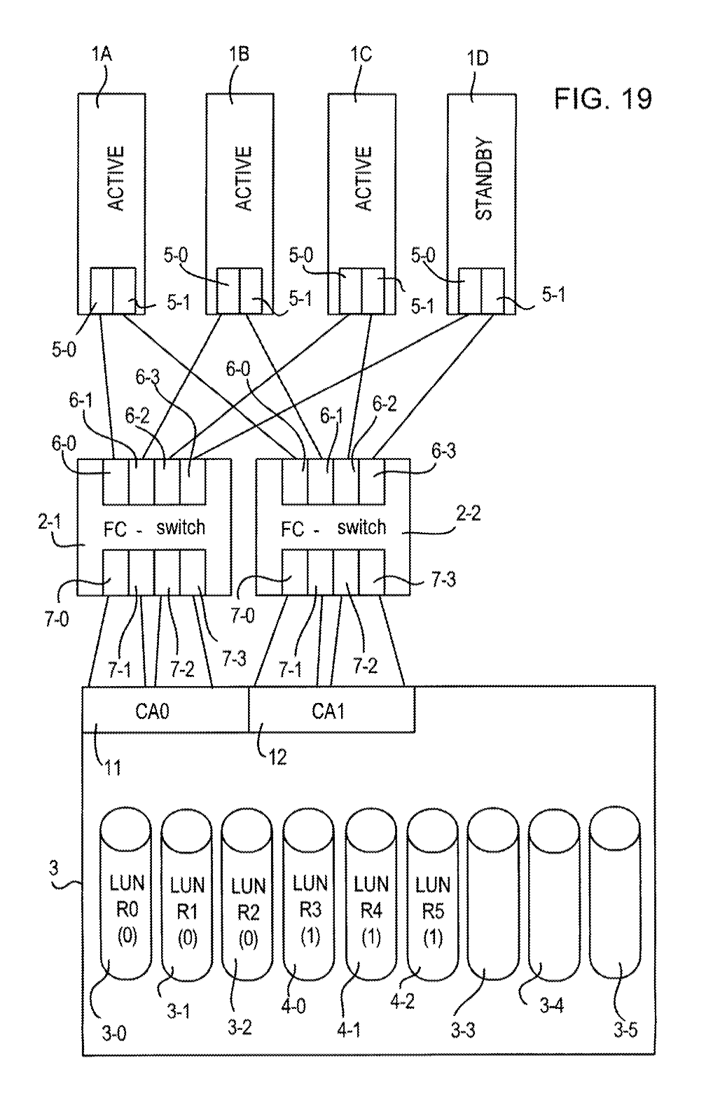

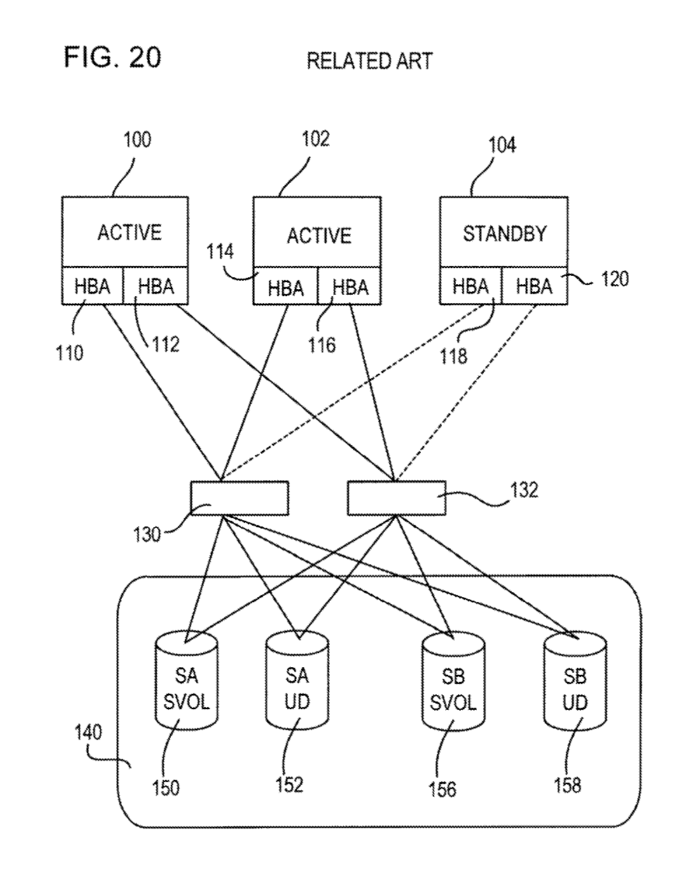

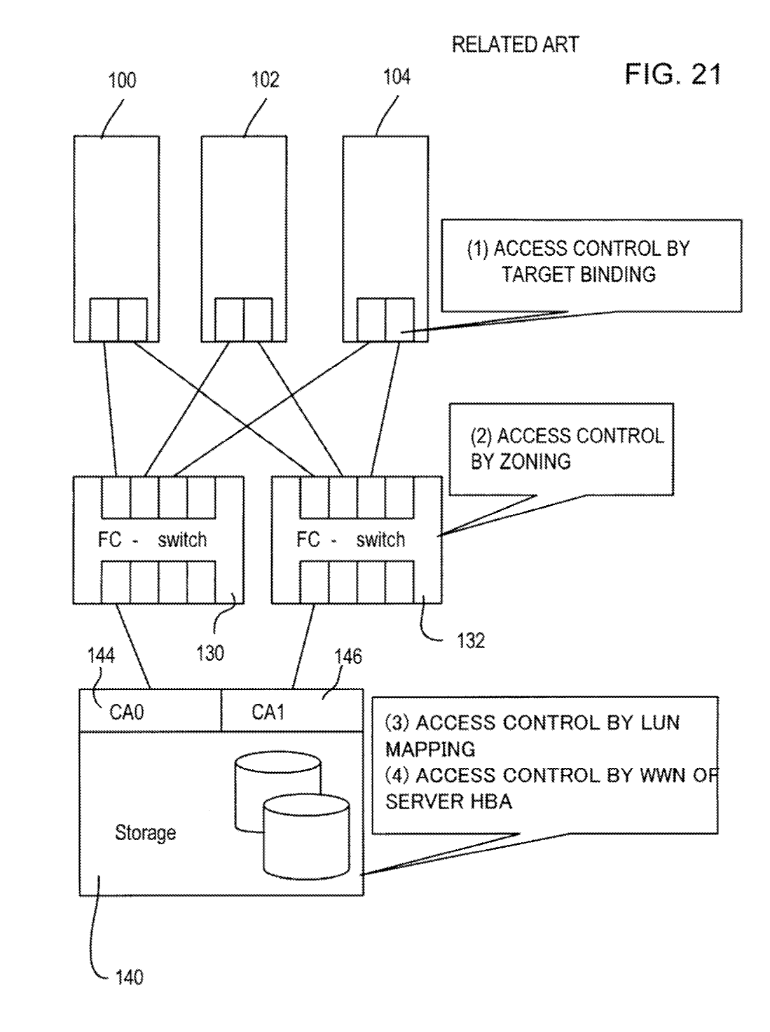

FIG. 19 is a block diagram of the computer system according to another embodiment. In FIG. 19, same elements as those described in FIG. 1˜FIG. 3, are indicated by same symbols. As illustrated by FIG. 19, the computer system includes a plurality of servers 1A˜1D. In an example of FIG. 19, three servers 1A, 1B, 1C configure an active processing system, and single server 11) configures a standby processing device for cold standby.

Each of the servers 1A, 1B, 1C, 1D includes at least a pair of host bus adapters (HBA: Host Bus Adapter) 5-0, 5-1, one or more processing device (CPU: Central Processing Unit) and a storage unit.

The servers 1A, 1B, 1C, 1D connect to the storage system 3 via a pair of switches (FC (Fibre Channel) switch) 2-1, 2-2. In the example of FIG. 19, in order to realize redundant connections between the servers 1A, 1B, 1C, 1D and the storage system 3, one host bus adapter 5-0 in each of the servers 1A, 1B, 1C, 1D connect to a first switch 2-1, and another host bus adapter in each of the servers 1A, 1B, 1C, 1D connect to a second switch 2-2.

Each of the switches 2-1 and 2-2 includes four ports 6-0-6-3 on the server side, and four ports 7-0˜7-3 on the storage system side.

The storage system 3 has at least two channel adapters 11 and 12. One channel adapter 11 connects to each of the ports 7-0˜7-3 in the first switch 2-1. Another channel adapter 12 connects to each of the ports 7-0˜7-3 in the second switch 2-2. The channel adapters in the storage system 3 also employ the redundant configuration.

The storage system 3 has system volume area (described as LUN R0 (0)) 3-0 and user data area (described as LUN R3 (1)) 4-0 of the server 1A, system volume area (described as LUN R1 (0)) 3-1 and user data area (described as LUN R4 (1)) 4-1 of the server 1B, and system volume area (described as LUN R2 (0)) 3-2 and user data area (described as LUN R5 (1)) 4-2 of the server 1C.

In addition, the storage system 3 has a copy area 3-3 of the system volume area (LUN R0 (0)) 3-0 of the server 1A, a copy area 3-4 of the system volume area (LUN R1 (0)) 3-1 of the server 1B and a copy area 3-5 of the system volume area (LUN R2 (0)) 3-2 of the server 1C.

These copy areas 3-3, 3-4 and 3-5 are volume area to be used by the standby server 1D. In other words, in the example, when switching to the standby server 1D from the failed server of the servers 1A, 1B and 1C, the server 1D uses one of the copy area 3-3, 3-4, 3-5 of the volume area of the filed server 1A, 18, 1C. This type is referred to as non-shared type.

In the configuration, the active servers 1A, 1B, 1C and the standby server 1D does not share only the system volume, but share the user volume. Thus, as same process as that in FIG. 6˜FIG. 8, the copy areas 3-3, 3-4, 3-5 are set for the standby server 1D, as the accessible volume. Then, when switching to the server 1D, one of the copy area 3-3, 3-4, 3-5 of the volume area of the failed servers 1A, 1B, 1C is set as the system volume 82-1 in the access list in FIG. 15.

In this manner; even in the non-shared system volume, setting operation can be simplified as well.

### Other Embodiments

In the embodiment described above, the example has been described in a system which uses three active servers and a single standby server, but it can also be applied to the system configuration having one or more active server and one or more standby server. Although the embodiment has been described in the network of the server and the storage system through the FC switch, but it can also be applied to other network configurations.

The foregoing has described the embodiments of the present invention, but within the scope of the spirit of the present invention, the present invention is able to various modifications, and it is not intended to exclude them from the scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention has been described in detail, it should be understood that the various changes, substitutions, and alterations could be made hereto without departing from the spirit and scope of the invention.

What is claimed is:

1. A storage system comprising;
a plurality of physical volumes that are accessed from a plurality of servers connected via a communication network path;
a storage unit that stores a first definition information which defines an exclusive access group of the server by address information of each access interface of the plurality of servers, a second definition information which defines an identification number of a logical volume which is permitted to access by the server for each of the exclusive access groups, and an access list which defines correspondence of the server included in the first definition information to the logical volume and the physical volume which are permitted to access in association with the first definition information and the second definition information; and
a control unit that receives an access request from the server, determines the exclusive access group, in which the access request of the server belongs to, by referring the first definition information by an address information included in the access request of the server, judges there is the physical volume corresponding to the server by referring the access list by the exclusive access group which is determined that the access request of the server belongs when determining the access request of the server belong to the exclusive access group which is defined, and controls an access of the physical volume by result of the judgment.

2. The storage system according to claim 1, wherein the control unit changes the correspondence between the server and the logical volume and the physical volume which are permitted to access in the access list according to a change of setting in the second definition information, and changes the server which is accessible to the logical volume and the physical volume which are permitted to access.

3. The storage system according to claim 2, wherein the control unit, when switching to a standby server from an active server among the plurality of servers, changes the correspondence between the server and the logical volume and the physical volume which are permitted to access in the access list according to a change of setting in the second definition information, and changes the server, which is accessible to the logical volume and the physical volume which are permitted to access, to the standby server.

4. The storage system according to claim 1, wherein the control unit, when the server, which issued the access request, does not belong to any of the exclusive access groups which are defined in the first definition information, responds an error to the server which issued the access request.

5. The storage system according to claim 2, wherein the control unit, when the server, which issued the access request, does not belong to any of the exclusive access groups which are defined in the first definition information, responds an error to the server which issued the access request.

6. The storage system according to claim 1, wherein the control unit, when determining that the physical volume corresponding to the server is not present by referring the access list, responds an error to the server which issued the access request.

7. The storage system according to claim 2, wherein the control unit, when determining that the physical volume corresponding to the server is not present by referring the access list, responds an error to the server which issued the access request.

8. The storage system according to claim 3, wherein the control unit, when determining that the physical volume corresponding to the server is not present by referring the access list, responds an error to the server which issued the access request.

9. The storage system according to claim 4, wherein the control unit, when determining that the physical volume corresponding to the server is not present by referring the access list, responds an error to the server which issued the access request.

10. The storage system according to claim 1, wherein the physical volume comprises at least user volume that stores user data of the server.

11. The storage system according to claim 1, wherein the physical volume comprises:
a user volume that stores user data of the server; and
a system volume that stores system information of the server.

12. A computer system comprising:
a plurality of servers that each executes processing; and
a storage system comprising
a plurality of physical volumes that are accessed from a plurality of servers connected via a communication network path;
a storage unit that stores a first definition information which defines an exclusive access group of the server by address information of each access interface of the plurality of servers, a second definition information which defines an identification number of a logical volume which is permitted to access by the server for each of the exclusive access groups, and an access list which defines correspondence of the server included in the first definition information to the logical volume and the physical volume which are permitted to access in association with the first definition information and the second definition information; and
a control unit that receives an access request from the server, determines the exclusive access group, in which the access request of the server belongs to, by referring the first definition information by an address information included in the access request of the server, judges there is the physical volume corresponding to the server by referring the access list by the exclusive access group which is determined that the access request of the server belongs when determining the access request of the server belong to the exclusive access group which is defined, and controls an access of the physical volume by result of the judgment.

13. A method of controlling an access to a storage system having a plurality of physical volumes that are accessed from a plurality of servers via a communication network path, the method comprising:
receiving an access request from the server by a control unit;
first determining an exclusive access group, in which the access request of the server belongs to, by referring a first definition information, which defines the exclusive access group of the server by address information of each access interface of the plurality of servers, by an address information included in the access request of the server;
second determining there is the physical volume corresponding to the server by referring an access list, which defines correspondence of the server included in the first definition information to the logical volume and the physical volume which are permitted to access in association with the first definition information and a second definition information, which defines an identification number of a logical volume which is permitted to access by the server for each of the exclusive access groups, by the exclusive access group which is determined that the access request of the server belongs when judging the access request of the server belong to the exclusive access group which is defined; and
controlling an access of the physical volume by result of the second determination.

14. The method according to claim 13, wherein the method further comprising:
changing the correspondence between the server and the logical volume and the physical volume which are permitted to access in the access list according to a change of setting in the second definition information; and
changing the server which is accessible to the logical volume and the physical volume which are permitted to access.

15. The method according to claim 14, wherein the method further comprising:
changing the correspondence between the server and the logical volume and the physical volume which are permitted to access in the access list according to a change of setting in the second definition information, when switching to a standby server from an active server among the plurality of servers; and
changing the server, which is accessible to the logical volume and the physical volume which are permitted to access, to the standby server.

16. The method according to claim 13, wherein the method further comprising responding an error to the server which issued the access request, when the server, which issued the access request, does not belong to any of the exclusive access groups which are defined in the first definition information.

17. The method according to claim 14, wherein the method further comprising responding an error to the server which issued the access request, when the server, which issued the access request, does not belong to any of the exclusive access groups which are defined in the first definition information.

18. The method according to claim 13, wherein the method further comprising responding an error to the server which issued the access request, when determining that the physical volume corresponding to the server is not present by referring the access list.

19. The method according to claim 14, wherein the method further comprising responding an error to the server which issued the access request, when determining that the physical volume corresponding to the server is not present by referring the access list.

20. The method according to claim 15, wherein the method further comprising responding an error to the server which issued the access request, when determining that the physical volume corresponding to the server is not present by referring the access list.
